(19) United States
(12) Patent Application Publication
(10) Pub. No.: US 2008/0288168 A1
(43) Pub. Date: Nov. 20, 2008

(54) Method for Determining the Position of Satellites in a Navigation System

(75) Inventor: Mathias Van Den Bossche, Goyrans (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/092,165

(22) PCT Filed: Oct. 31, 2006
(86) PCT No.: PCT/FR2006/051128

§ 371 Date: May 28, 2008

(30) Foreign Application Priority Data
Nov. 2, 2005 (FR) 0553313

(51) Int. Cl. G01S 5/14

(52) U.S. Cl. 701/226

(57) ABSTRACT

This invention relates to a method for determining the position of satellites in a satellite navigation system.

The method uses satellite position data (42) external to the navigation system and referenced in a coordinate system related to the earth, these data being converted (33) into a Galilean coordinate system to calculate (34) satellite orbits, predictions (43) of satellite positions being determined from orbits converted into the Galilean coordinate system.

Subsequently, two solutions are possible to transfer data into a coordinate system related to the earth. In a first solution, coordinates are transferred in a central manner into the coordinate system related to the earth, and navigation data are then prepared and transmitted in advance to users. In a second solution, coordinates related to the Galilean coordinate system are transmitted to users directly and the transfer into the coordinate system related to the earth is made on the user's equipment.

The invention is used particularly to increase the validity duration of position data.

### CROSS-REFERENCE TO RELATED APPLICATIONS

The present Application is based on International Application No. PCT/FR2006/051128, filed on Oct. 31, 2006, which in turn corresponds to French Application No. 0553313, filed on Nov. 2, 2005, and priority is hereby claimed under 35 USC §119 based on these applications. Each of these applications are hereby incorporated by reference in their entirety into the present application.

### FIELD OF THE INVENTION

This invention relates to a method for determining the position of satellites in a satellite navigation system. It is particularly applicable for increasing the validity duration of position data.

### BACKGROUND OF THE INVENTION

Satellite navigation systems are usually referred to as GNSS (Global Navigation Satellites System). These systems comprise a constellation of satellites moving around the earth. In a satellite positioning system, the position of an object, in other words its coordinates in space, is determined in a known manner by determining the propagation time of a particular hyper frequency wave between each satellite and the object, the propagation time being used to determine the distance from the object to the satellite. Knowledge of the distance from at least four satellites and the position of the satellites themselves then provides a means of determining the position of the object.

Therefore, knowledge of the position of satellites is an important element in determining the position of objects. Satellites rotate about the earth around their orbit. The result is that navigation data provided by satellites have several disadvantages. Firstly, these data are only valid for a short period, typically of the order of 4 hours, and therefore must be updated regularly as a consequence of approximations necessary for production and dissemination of data. The result is a series of problems in the services development context in which other information sources (land network, geostationary satellite, etc.) are added to the main navigation system, in particular:
the frequency at which navigation data are updated makes use of data flows that cause congestion on communication networks;
the frequency at which navigation data are updated means that it is difficult for a user to be independent, particularly in the case in which he loses the communication network for longer than the data validity period;
the duration of the navigation data validity period prevents a user located far from the service centre which is processing his data from using this service centre since the same satellites must be visible at the same time both for the user and for this service centre, which causes a problem particularly when the user makes long trips.

All these problems cause degradation of navigation data produced by satellites with time. Note that degradation of navigation data produced by satellites is greater for the prediction of their position than for prediction of the offset of their atomic clock. For positioning, there is a fast increase in the error as a function of the time by which the data validity period is exceeded, while the error for the clock offset does increase, but more slowly.

Satellite position data are transmitted to users through navigation messages by a set of orbital parameters. These orbital parameters are parameters for a parametric equation of an orbit described by a Kepler law slightly modified so as to include different types of distortions to take account of second order effects of forces other than the gravity potential of a spherical earth, in the satellite trajectory. This type of orbit will subsequently be called a quasi-keplerian orbit. These parameters are obtained by integrating the equation of motion of a satellite to predict positions on the satellite trajectory. The parameters for the equation of a parametric trajectory representing a portion of a quasi-keplerian orbit are obtained by adjustment of a quasi-keplerian trajectory on these predicted positions. The satellite position data are then provided using these adjusted parameters. As previously indicated, these satellite position data degrade with time. One cause of this degradation is particularly the problem described below.

The parametric equation for a quasi-keplerian orbit is a valid model to describe satellite positions only with reference to a Galilean coordinate system. However, for practical reasons, the quasi-Keplerian parametric equation is used to broadcast coordinates of satellite positions in a coordinate system that follows the rotation movement of the earth. This coordinate system is non-Galilean. For this reason, it is undoubtedly possible to obtain a reliable trajectory but for a short time interval with a finite and known duration. The predicted trajectory and the real trajectory of the satellite diverge considerably outside this time interval.

The non-Galilean coordinate system in which the position coordinates of a satellite are given is a coordinate system related to the earth, therefore this coordinate system rotates with the earth. The reason why such a coordinate system is used is that all other data used by users of the service, for example such as coordinate systems of digital map models, are referenced with respect to this earth coordinate system. The result is that use of this coordinate system for referencing satellite position data is practically inevitable.

### SUMMARY OF THE INVENTION

One particular purpose of the invention is to overcome the above-mentioned disadvantages, particularly to extend the validity of the above-mentioned satellite position data broadcast in the form of coordinates with respect to a coordinate system related to the earth. To achieve this, the purpose of the invention is a method for determining the position of satellites in a navigation system that uses satellite position data external to the navigation system and referenced in a coordinate system related to the earth. These data are converted into a Galilean coordinate system to calculate satellite orbits, predictions of satellite positions being determined from orbits converted into the Galilean coordinate system.

The method also preferably uses navigation data internal to the navigation system and referenced in a coordinate system related to the earth, to calculate orbits.

In one possible embodiment, the method comprises:
a first step in which satellite position data are collected,
a subsequent step in which values of the earth's rotation parameters are collected;
a step in which position coordinates of satellites are calculated in the coordinate system related to the earth;
a step in which the position coordinates are converted into the Galilean coordinate system using earth rotation parameters;
a step in which an orbit is calculated for each satellite as a function of coordinates referenced in the Galilean coordinate system.

Data collected in the first step advantageously comprise data external to the navigation system. For example, these data are produced by the EGNOS or WAAS systems or by other public bodies, for example such as the IGS organization.

Preferably, data collected in the first step also comprise data internal to the navigation system.

In a first possible embodiment of the method according to the invention, satellite position predictions are produced with reference to the Galilean coordinate system and these coordinates are then converted into the coordinate system related to the earth before being transmitted to users of the navigation system. The method according to the invention may then include the following steps after the steps described above:
a step in which sets of satellite position coordinate predictions in the Galilean coordinate system are produced;
a step in which coordinates in the coordinate system related to the earth are converted using earth rotation parameters predicted in a previous step;
a step in which several navigation messages are prepared, each message comprising sets of satellite position coordinates in the coordinate system related to the earth, sets of coordinates produced following the progress of satellites on their trajectories;
a step in which prepared messages are transmitted to users.

In a second possible embodiment of the method according to the invention, satellite position coordinates related to the Galilean coordinate system are transmitted directly to users of the navigation system, data conversion in the coordinate system related to the earth being made on the user's equipment. In this case, the method comprises the following additional steps:
a step in which predictions of orbit parameters related to the Galilean coordinate system are transmitted to users;
a step in which existing earth rotation parameters are collected from user's equipment;
a step in which satellite position coordinates are calculated on the user's equipment, in the Galilean coordinate system starting from predictions of orbit parameters obtained in a previous step;
a subsequent step in which related satellite position coordinates in the Galilean coordinate system are converted into position coordinates in the earth coordinate system on the user's equipment, using earth rotation parameters collected in a previous step.

The invention has the particular advantages that it can be used to extend the validity of satellite position data, and also this possibility can be extended to the case in which coordinates are distributed with respect to an appropriate Galilean coordinate system. The invention also enables a calculation of satellite position coordinates based on the use of public reference data and eliminates the need for a physical model of the problem. Finally, it is easy to implement.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 shows an illustration of the orbit of a satellite referenced in a Galilean coordinate system;

FIG. 2 shows an illustration of the orbit of the previous satellite referenced in a reference system related to the earth;

FIG. 3 shows an illustration of possible steps for implementation of a method according to the invention;

FIG. 4 shows an illustration of position data processing performed during the previous steps;

FIG. 5 shows a series of subsequent steps according to a first embodiment;

FIG. 6 shows a series of subsequent steps according to a second embodiment.

### DETAILED DESCRIPTION OF THE DRAWINGS

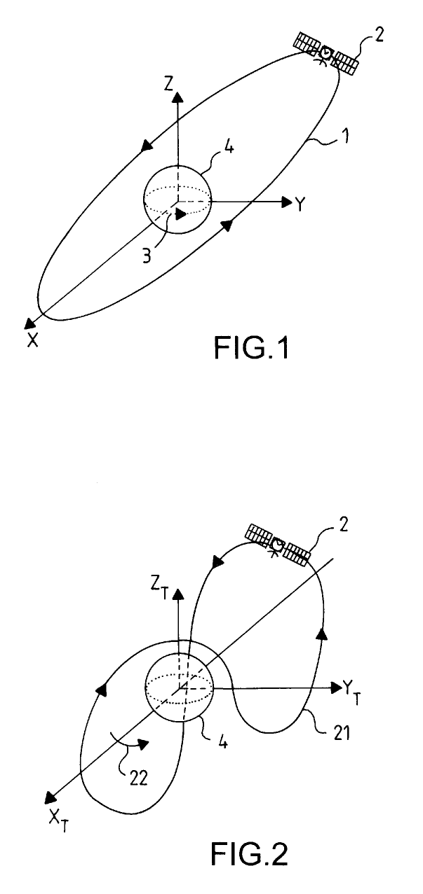

FIG. 1 shows a trajectory 1 of a satellite 2 in a GNSS system referenced in a Galilean X, Y, Z coordinate system independent of the rotation movement 3 of the Earth 4. This trajectory 1 that is the orbit of satellite 2 around the earth is approximately an ellipse. The parameters of this quasi-keplerian orbit are perfectly defined to describe the curve representing the trajectory 1 in three-dimensional space, these parameters being referenced to the Galilean coordinate system X, Y, Z.

FIG. 2 shows the trajectory 21 of the satellite 2 referenced in a non-Galilean X_{T}, Y_{T}, Z_{T} coordinate system related to the earth 4. In particular, this coordinate system X_{T}, Y_{T}, Z_{T} rotates with the earth following the same rotation movement 22. In this non-Galilean coordinate system, the trajectory 21 is no longer an ellipse. This trajectory 21 describes a surface in the form of a saddle. More particularly, the shape of the trajectory 21 is like the line printed on a tennis ball. Given that the trajectory 21 describes a sort of twisted ellipse, quasi-keplerian orbit parameters referenced at the X_{T}, Y_{T}, Z_{T} coordinate system related to the earth can be used to describe short segments of the curve representative of this trajectory 21. However, it is clear that such parameter settings for the trajectory 21 are valid only for short periods and very quickly lead to large positioning errors of the satellite 2 for which the real elliptical trajectory 1 very quickly moves away from the trajectory 21 seen by the X_{T}, Y_{T}, Zₜ coordinate system related to the earth. For example this is the case for position data emitted by satellites in the GPS system, and will certainly also be the case for data emitted by the future Galileo system, because data output by these systems are referenced to the earth's coordinate system. Thus, for anyone that depends on position data emitted by satellites, frequent connections to the source of these position data have to be made to maintain the navigation service. This is clearly a problem when the source of navigation data is another channel, for example such as a mobile telephone network envisaged for position search applications, and more generally all positioning applications, rather than a navigation message emitted by a satellite. In particular, this creates congestion of the network.

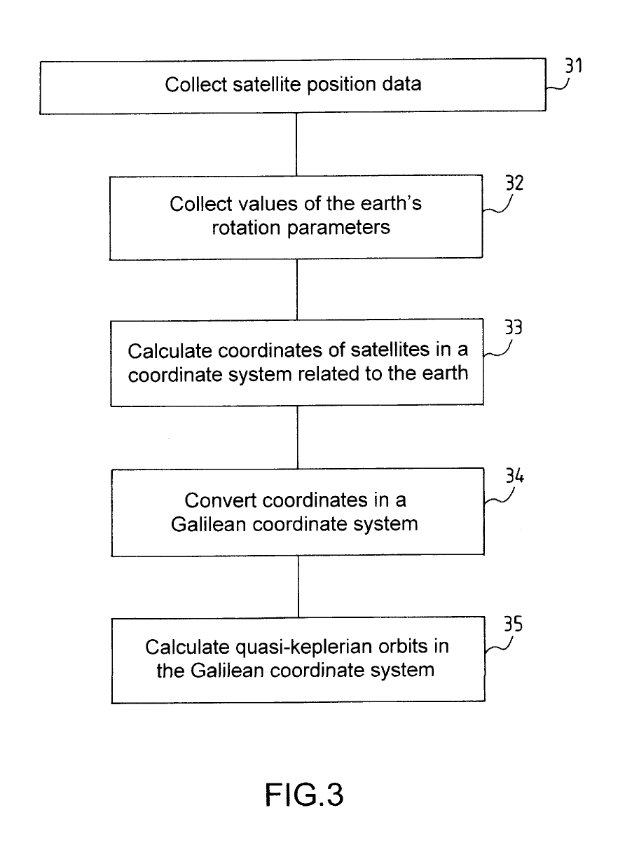

FIG. 3 shows the possible steps in a method according to the invention. The invention enables independent use of satellite position data over a relatively long validity period through the combined use of existing data with a short validity period and earth rotation parameters. Satellites that are taken into account are those that are necessary to calculate the position of an object during the validity period considered, at least four satellites have to be taken into consideration.

In a first step 31, GNSS satellite position data are collected. In particularly, these data consist of public data produced by messages emitted by the GNSS systems themselves such as GPS and Galileo. External data are also collected alongside these data internal to the navigation system itself, for example data produced by the EGNOS (European Geostationary Navigation Overlay Service) or the WAAS (Wide Area Augmentation System) systems that check and correct the GPS data. Other position data can also be collected, for example such as data provided by other public bodies such as IGS (International GNSS Service) that continuously monitor the GPS constellation and reconstruct satellite orbits with good precision.

Values of the earth's rotation parameters are collected in a subsequent step 32. For example, these data are collected from new GPS navigation messages that comprise data, or messages emitted by IGS type public bodies, for example that also provide predictions of earth parameters. Existing earth rotation parameters are collected in this step 32, together with predicted parameters corresponding to future predictions of satellite positions. This step 32 may possibly be done before the previous step 31.

In a next step 33, position coordinates of satellites are calculated in a coordinate system X_{T}, Y_{T}, Z_{T} related to the earth using position data collected during the first step 31 during their corresponding validation duration. In particular, data derived from the GPS may for example be corrected using data provided by the EGNOS or the WAAS systems.

In a subsequent step 34, these coordinates calculated in the previous step 33 are transferred into a Galilean coordinate system X, Y, Z using the earth's rotation parameters collected in a previous step 32, using a conventional conversion method. This is possible due to the fact that the earth's reference system X_{T}, Y_{T}, Z_{T} is connected to the earth and follows its rotation movements. The earth's rotation parameters used are the parameters that are valid at the time at which the corresponding position data of the satellites are valid. Data thus transferred into the Galilean X, Y, Z coordinate system will be used to set parameters for a quasi-keplerian orbit of the type shown in FIG. 1.

Thus, in a subsequent step 35, a quasi-keplerian parametric curve is calculated for each satellite as a function of coordinates referenced in the Galilean coordinate system and obtained during the previous step 34. This curve follows the orbit assumed to be followed by the satellite. The result is then a series of satellite positions that are valid in the long term because they are referenced in a Galilean coordinate system. It should be noted that at this stage, there is no need for the quasi-keplerian orbit obtained to be strictly of the GPS type, in other words there is no need to use all parameters used in a GPS system to define the quasi-keplerian orbit.

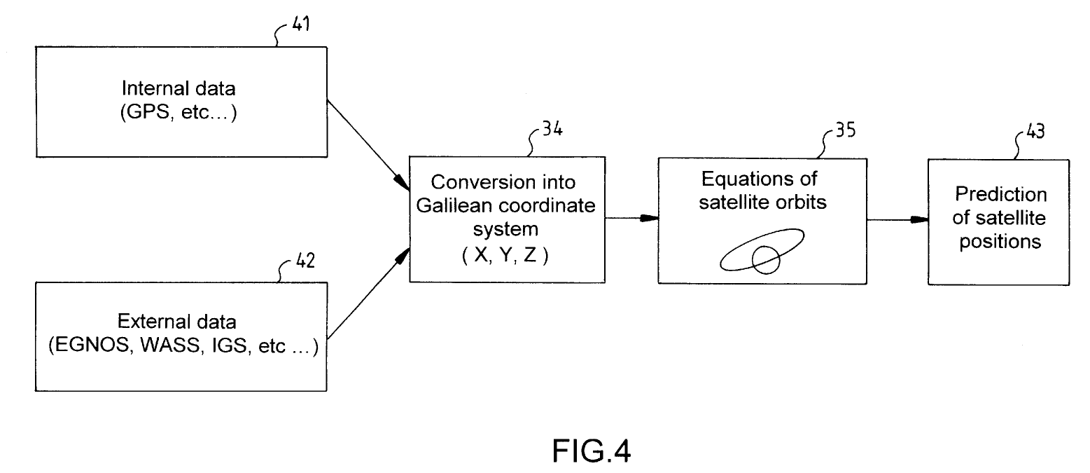

FIG. 4 shows a mimic diagram showing processing of position data made during previous steps. At this stage, the method according to the invention used precise coordinate system change information, particularly earth rotation parameters to transfer internal navigation data 41 and external navigation data 42 to the navigation system in a Galilean coordinate system, in a step 34. In particular, the external navigation data 42 can be collected over a long time period. Therefore, quasi-keplerian orbits can advantageously be prolonged over a time period much longer than existing validity durations of satellite position data. Also advantageously, steps in the method according to the invention are carried out without any detailed modelling of the physical environment, which facilitates implementation. Furthermore, users of services can use satellite position data independently for a long period.

Therefore, during a subsequent step 35, equations of satellite orbits are calculated from external position data 42 converted into the Galilean coordinate system. In particular, position data 41 internal to the GPS type system can be used for calculating orbits. These orbits can be used to obtain satellite position predictions 43 over the long term. Therefore, the position coordinates are available at the end of this step 35, with reference to a Galilean coordinate system.

However, these coordinates are not necessarily adapted to users, because most other data used by users are usually referenced to a non-Galilean coordinate system, related to the earth. For example, according to the invention, at least two solutions are possible to transfer data into a coordinate system related to the earth, more suitable for users of the navigation system:
either coordinates can be transferred in a central manner into the coordinate system related to the earth, and navigation data can then be prepared and transmitted in advance;
or coordinates related to the Galilean coordinate system can be transmitted to users directly and the transfer into the coordinate system related to the earth can be made on the user's equipment.

This second solution means that all that is necessary is to send a set of calculated orbit parameters to users during the validity period of the position data. Advantageously, this avoids congestion on the network.

The two solutions are presented below.

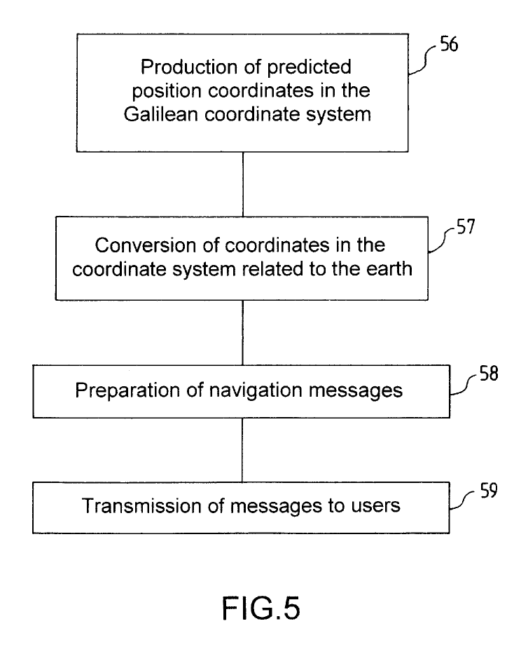

FIG. 5 shows the first solution. In this phase, data referenced to a coordinate system X_{T}, Y_{T}, Z_{T} related to the earth are distributed in the long term. In a next step 56, a set of predictions of coordinates of satellite positions in the Galilean coordinate system X, Y, Z are produced using coordinates defined in the previous step 35, these data being valid in the long term. Each prediction corresponds to a predetermined future date.

In a next step 57, these coordinates are transferred to the earth coordinate system X_{T}, Y_{T}, Z_{T} by means of predicted earth rotation parameters collected in a previous step 32, for example using a conventional conversion method. This is an inverse transfer from that done in a previous step 34. Parameters for the quasi Keplerian orbit of satellites are then set in the earth coordinate system.

In a subsequent step 58, several navigation messages are prepared in advance for several future time intervals. Each message comprises parameters of satellite orbits referenced with respect to the earth coordinate system and obtained in previous step 57. The different sets of coordinates produced follow the progress of satellites over their quasi-keplerian trajectories produced in this previous step 57 with reference to the earth's coordinate system.

Finally in the next step 59, prepared messages are transmitted in advance to users. To reduce the quantity of transmitted data, it is possible to transmit only those parameters that have been modified from one message to the next.

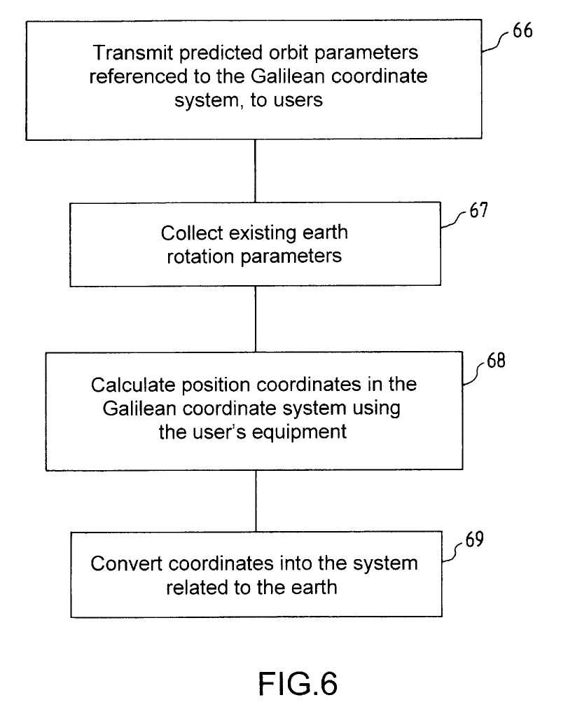

FIG. 6 shows the second possible solution for implementation of a method according to the invention. In this phase, data referenced to a Galilean coordinate system are distributed in the long term.

In a subsequent step 66, predictions of position data referenced to the Galilean coordinate system are transmitted to users, these coordinates being valid in the long term.

In a subsequent step 67, users collect the earth's current rotation parameters. The users collect these current parameters so as to make a coordinate system transfer in a subsequent step. For example, users collect these coordinates using GPS L5 messages that should comprise the earth rotation parameters. These parameters can also be transmitted regularly by the service provider. Obviously, other information sources could be used.

In a subsequent step 68, satellite position coordinates in the Galilean coordinate system are calculated on the user's equipment using position data predictions obtained in the previous step 66. Finally in the next step 69, satellite position coordinates referenced in the Galilean coordinate system are converted into position coordinates in the coordinate system related to the earth on the user's equipment using earth rotation parameters collected in the previous step 67.

Thus, at the end of the steps in the two solutions described above, the result is data referenced in an earth coordinate system, and therefore compatible with other data provided by other systems. Furthermore, these position data are valid over a long period because they eventually relate to a quasi-keplerian orbit corresponding to a satellite trajectory over this period. The validity duration may be as much as several days.

Data collected in the different steps are memorized, for example in the server of a processing centre of a positioning or navigation service. This server also comprises for example calculation means necessary for transfers and production of different position coordinates. In particular, all prediction calculations that are done centrally, unlike calculations done on the user's equipment, are done in service centres that then transmit the results to the navigation system users. More generally, centralisation of collections and prediction calculations could be envisaged at a server, or decentralisation at receivers with sufficient calculation powers.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for determining the position of satellites in a navigation system, comprising the steps of:
using satellite position data external to the navigation system and referenced in a coordinate system (X_{T}, Y_{T}, Z_{T}) related to the earth, converting the data into a Galilean coordinate system (X, Y, Z) to calculate orbits of satellites, predictions of satellite positions being determined from orbits converted into the Galilean coordinate system (X, Y, Z).

2. The method according to claim 1, further comprising using navigation data internal to the navigation system and referenced in a coordinate system (X_{T}, Y_{T}, Z_{T}) related to the earth, to calculate orbits.

3. The method according to claim 1, wherein:
in a first step, position data of satellites are collected,
in a subsequent step, values of the earth's rotation parameters are collected;
in a subsequent step, position coordinates of satellites are calculated in the coordinate system related to the earth (X_{T}, Y_{T}, Z_{T});
in a subsequent step, the position coordinates are converted into the Galilean coordinate system (X, Y, Z) using earth rotation parameters;
in a subsequent step, an orbit is calculated for each satellite as a function of coordinates referenced in the Galilean coordinate system (X, Y, Z).

4. The method according to claim 3, wherein data collected in the first step comprise data external to the navigation system.

5. The method according to claim 4, wherein data are produced by the EGNOS or WAAS systems.

6. The method according to claim 4, wherein data are produced by the IGS organisation.

7. The method according to claim 3, wherein data collected in the first step comprise data internal to the navigation system.

8. The method according to claim 1, wherein satellite position predictions are produced with reference to the Galilean coordinate system and these coordinates are then converted into the coordinate system related to the earth before being transmitted to users of the navigation system.

9. the method according to claim 8, wherein:
sets of satellite position coordinate predictions in the Galilean coordinate system (X, Y, Z) are produced;
in a subsequent step, coordinates in the coordinate system (X_{T}, Y_{T}, Z_{T}) related to the earth are converted using earth rotation parameters predicted in a previous step;
in a subsequent step, several navigation messages are prepared, each message comprising sets of satellite orbit parameters in the coordinate system (X_{T}, Y_{T}, Z_{T}) related to the earth, sets of coordinates produced following the progress of satellites on their trajectories;
in a subsequent step, prepared messages are transmitted to users.

10. The method according to claim 1, wherein satellite position coordinates related to the Galilean coordinate system are transmitted directly to users of the navigation system, data conversion in the coordinate system related to the earth being made on the user's equipment.

11. The method according to claim 10, wherein:
in a step, predictions of orbit parameters related to the Galilean coordinate system are transmitted to users;
in a subsequent step, existing earth rotation parameters are collected from user's equipment;
in a subsequent step, satellite position coordinates are calculated on the user's equipment, in the Galilean coordinate system starting from predictions of orbit parameters obtained in a previous step;
in a subsequent step, related satellite position coordinates in the Galilean coordinate system are converted into position coordinates in the coordinate system related to the earth on the user's equipment, using earth rotation parameters collected in a previous step.

12. The method according to claim 2, wherein:
in a first step, position data of satellites are collected,
in a subsequent step, values of the earth's rotation parameters are collected;
in a subsequent step, position coordinates of satellites are calculated in the coordinate system related to the earth (X_{T}, Y_{T}, Z_{T});
in a subsequent step, the position coordinates are converted into the Galilean coordinate system (X, Y, Z) using earth rotation parameters;
in a subsequent step, an orbit is calculated for each satellite as a function of coordinates referenced in the Galilean coordinate system (X, Y, Z).

13. The method according to claim 5, wherein data are produced by the IGS organisation.

14. The method according to claim 4, wherein data collected in the first step comprise data internal to the navigation system.

15. The method according to claim 5, wherein data collected in the first step comprise data internal to the navigation system.

16. The method according to claim 2, wherein satellite position coordinates related to the Galilean coordinate system are transmitted directly to users of the navigation system, data conversion in the coordinate system related to the earth being made on the user's equipment.

17. The method according to claim 3, wherein satellite position coordinates related to the Galilean coordinate system are transmitted directly to users of the navigation system, data conversion in the coordinate system related to the earth being made on the user's equipment.

18. The method according to claim 4, wherein satellite position coordinates related to the Galilean coordinate system are transmitted directly to users of the navigation system, data conversion in the coordinate system related to the earth being made on the user's equipment.

19. The method according to claim 5, wherein satellite position coordinates related to the Galilean coordinate system are transmitted directly to users of the navigation system, data conversion in the coordinate system related to the earth being made on the user's equipment.

20. The method according to claim 6, wherein satellite position coordinates related to the Galilean coordinate system are transmitted directly to users of the navigation system, data conversion in the coordinate system related to the earth being made on the user's equipment.
